(19) United States
(12) Patent Application Publication
(10) Pub. No.: US 2009/0323204 A1
(43) Pub. Date: Dec. 31, 2009

(54) LENS, METHOD FOR FABRICATING SAME AND LENS MODULE HAVING SAME

(75) Inventor: YI-MOU HUANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/247,391

(22) Filed: Oct. 8, 2008

(30) Foreign Application Priority Data
Jun. 26, 2008 (CN) 200810302367.3

(51) Int. Cl. G02B 1/10; G02B 3/00; B29D 11/00; G02B 7/02

(52) U.S. Cl. 359/738; 264/1.7

(57) ABSTRACT

A lens includes a central optical portion, and a peripheral supporting portion surrounding the central optical portion. The peripheral supporting portion has a first surface and an opposite second surface. At least one of the first surface and second surface having a light absorbing polymer layer adhered thereon.

### BACKGROUND

1. Technical Field

The present invention relates to lenses, methods for fabricating the lenses, and lens modules.

2. Description of Related Art

With the ongoing development of microcircuitry and multimedia technology, camera modules, including, e.g., still camera modules and digital camera modules are now in widespread use and are being combined with various electronic devices. Such camera modules are required to have excellent optical characteristics.

Lens modules and image sensors are key components of the camera modules. Referring to FIG. 9, a typical lens module 100 includes a lens barrel 110, and two lenses 130 and a spacer 120 received in the lens barrel 110. Each of the lenses 130 has a central optical portion 131 and a peripheral supporting portion 132 surrounding the central optical portion 131. The central optical portion 131 of each of the lenses 130 is aligned with an opening 112 of the lens barrel 110, and the peripheral supporting portion 132 of each of the lenses 130 is adjacent to the lens barrel 110 and the spacer 120. Generally, the central optical portion 131 is configured to capture a light from object.

The peripheral supporting portion 132 and the central optical portion 131 are usually integrally made from a transparent material. That is, even block by the spacer 120 and the lens barrel 110, the light may still transmit through the lens 130 from the peripheral supporting portion 132 and intervenes the light transmit through central optical portion 131 of the lens 130. This may negatively impact the image quality of the object.

What is needed, therefore, is a lens and a method for fabricating the lens, which can overcome the above shortcomings, and a lens module having the lens.

### SUMMARY

A lens includes a central optical portion, and a peripheral supporting portion surrounding the central optical portion. The peripheral supporting portion has a first surface and an opposite second surface. At least one of the first surface and second surface having a light absorbing polymer layer adhered thereon.

Other advantages and novel features of the present lens will become more apparent from the following detailed description of embodiment when taken in conjunction with the accompanying drawings.

### BRIEF DESCRIPTION OF THE DRAWINGS

Many aspects of the lens, the method and the lens module can be better understood with reference to the following drawings. The components in the drawings are not necessarily drawn to scale, the emphasis instead being placed upon clearly illustrating the principles of the present lens, method and lens module. Moreover, in the drawings, like reference numerals designate corresponding parts throughout the several views.

FIG. 1 is a cross-sectional view of a lens in accordance with a first embodiment.

FIG. 2 is a plan view of the lens of FIG. 1.

FIG. 3 is cross-sectional view of a lens in accordance with a second embodiment.

FIG. 4 is a plan view of the lens of FIG. 3.

FIG. 5 is a cross-sectional view of one embodiment of a lens module.

FIG. 6, FIG. 7 and FIG. 8 show one embodiment of a method for fabricating a lens.

FIG. 9 is a cross-sectional view of a typical lens module.

### DETAILED DESCRIPTION OF THE EMBODIMENTS

Embodiments of the present lens, method and lens module will now be described in detail below and with reference to the drawings.

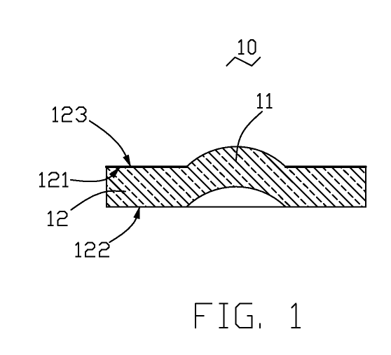

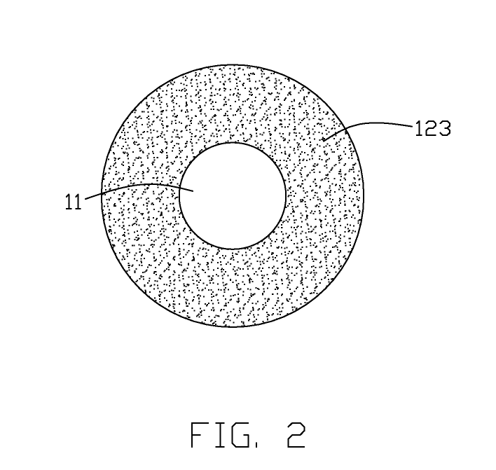

Referring to FIGS. 1 and 2, a lens 10 in accordance with a first embodiment, is shown. The lens 10 includes a central optical portion 11, and a peripheral supporting portion 12 surrounds the central optical portion 11. The peripheral supporting portion 12 has a light absorbing polymer layer 123 adhered thereon.

The central optical portion 11 may be aspherical shaped, or spherical shaped. The peripheral supporting portion 12 has a flat first surface 122 and an opposite flat second surface 121. The central optical portion 11 and the peripheral supporting portion 12 are made of a transparent material. The light absorbing polymer layer 123 is adhered to and entirely covered on the second surface 121. The light absorbing polymer contains an atrament. The atrament may be selected from a group consisting of polyethylene terephthalate and liquid-crystal polymer. A thickness of the light absorbing polymer layer 123 is preferably in range from 50 μm to 650 μm.

The light absorbing polymer layer 123 may also be applied on the first surface 122.

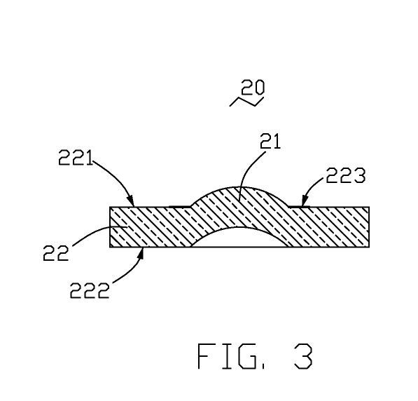

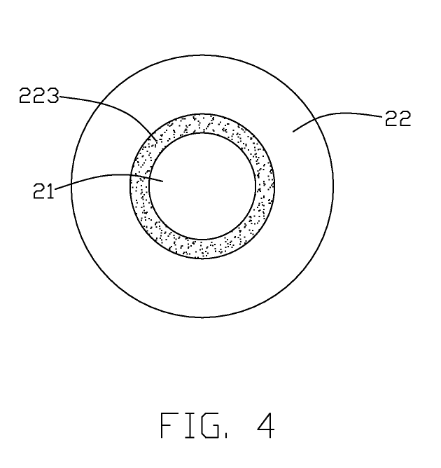

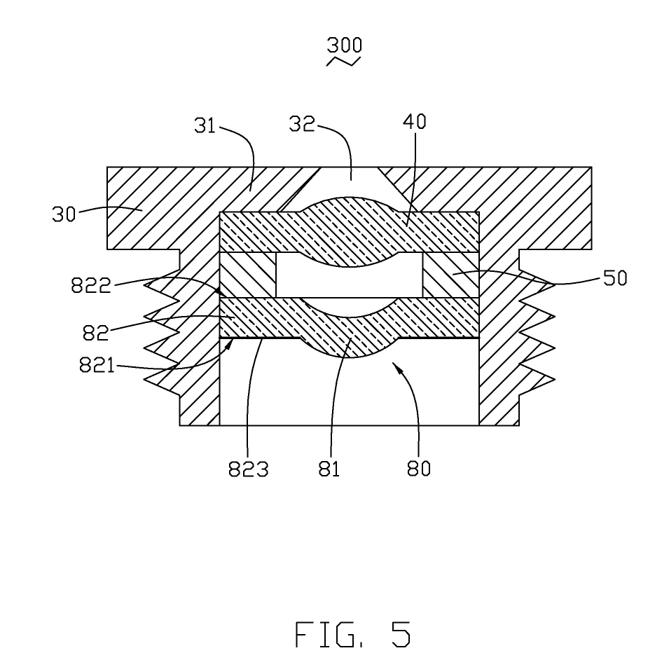

Referring to FIGS. 3 and 4, a lens 20 in accordance with a second embodiment, is shown. The lens 20 includes a central optical portion 21, and a peripheral supporting portion 22 surrounds the central optical portion 21. The peripheral supporting portion 22 has a first surface 222 and an opposite second surface 221. The lens 20 is similar to the lens 10 illustrated above, however, a light absorbing polymer layer 223 covers only a circular part of the second surface 221. The light absorbing polymer layer 223 is in a ring shape and defined adjacent to the central optical portion 21 of the lens 20.

The light absorbing polymer layer 123 may also be applied on the first surface 122.

Referring to FIG. 5, one embodiment of a lens module 300 is shown. The lens module 300 includes a lens barrel 30, a first lens 40, a spacer 50 and a second lens 80. A bottom of the lens barrel 30 has a retaining portion 31 with a through hole 32 defined at a central portion. The first lens 40 is arranged on the retaining portion 31, the spacer 50 is arranged between the first lens 40 and the second lens 80. The second lens 80 may be the same as the lens 10 illustrated above. A first surface 822 of the peripheral supporting portion 82 of the second lens 80 faces towards the spacer 50, and an opposite second surface 821 of the second lens 80 has a light absorbing polymer layer 823 adhered thereon. The light absorbing polymer layer 823 entirely covers the second surface 821. The light absorbing polymer layer 823 is used to absorb light projected on the peripheral supporting portion 82. Such that, light projected on the central optical portion 81 can transmit through the second lens 80 without any intervenes, and then transmit through the first lens 40 to an image sensor (not shown).

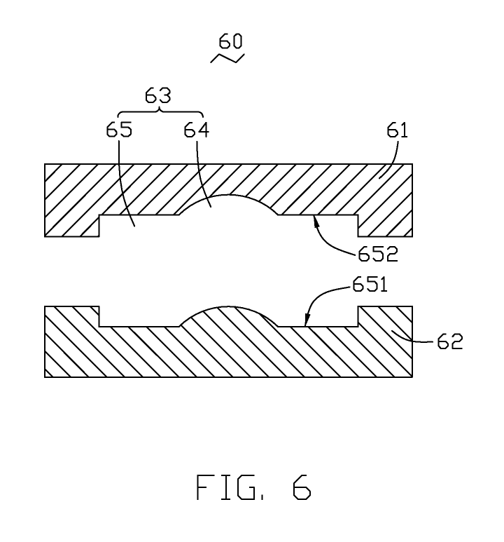

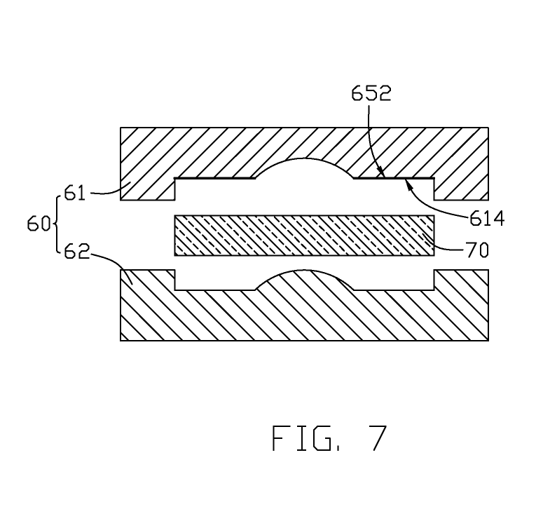

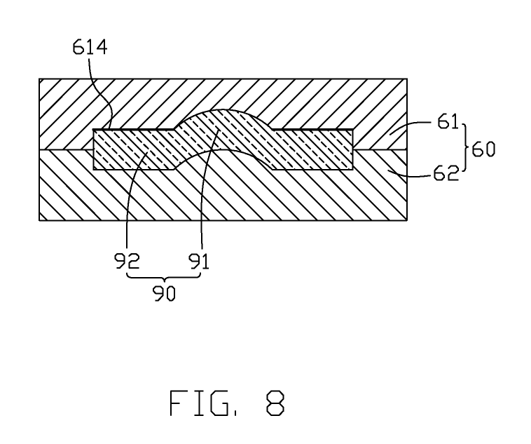

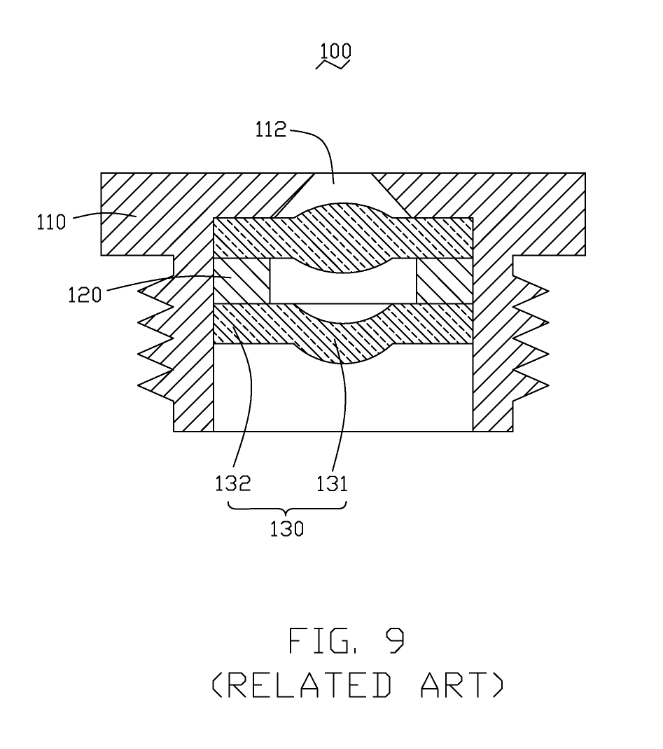

Referring to FIGS. 6 to 8, one embodiment of a method for fabricating a lens 90 is shown. The method includes the following blocks.

First, a mold 60 is provided. The mold 60 includes a first part 61 and a second part 62. The first part 61 and the second part 62 cooperate to form a chamber 63 including a central portion 64 and a peripheral portion 65. The central portion 64 and the peripheral portion 65 are to form a corresponding central optical portion 91 and a corresponding peripheral supporting portion 92 of the lens 90. The peripheral portion 65 has a first inner surface 651 and an opposite second inner surface 652.

Second, a light absorbing polymer 614 is applied on the second inner surface 652 of the peripheral portion 65 of the chamber 63. Third, a lens material 70 is introduced into the chamber 63 and the chamber 63 is heated. Then the central optical portion 91 and the peripheral supporting portion 92 of the lens 90 are formed, the light absorbing material 614 will adhered on the peripheral supporting portion 92 due to the heat. Finally, the first part 61 and the second part 62 of the mold 60 are removed, and a lens 90 having a light absorbing polymer layer of the light absorbing polymer 614 adhered on the peripheral supporting portion 92 thereof can be obtained.

It is understood that the above-described embodiments are intended to illustrate rather than limit the invention. Variations may be made to the embodiments and methods without departing from the spirit of the invention. Accordingly, it is appropriate that the appended claims be construed broadly and in a manner consistent with the scope of the invention.

What is claimed is:

1. A lens comprising:
a central optical portion; and
a peripheral supporting portion surrounding the central optical portion, the peripheral supporting portion having a first surface and an opposite second surface, at least one of the first surface and second surface having a light absorbing polymer layer adhered thereon.

2. The lens of claim 1, wherein the light absorbing polymer layer covers at least one of the entire first and second surfaces of the peripheral supporting portion.

3. The lens of claim 1, wherein at least one of the first surface and second surface includes a covered portion proximate to the central optical portion and an exposed portion free of light absorbing polymer layer thereon, and the light absorbing polymer layer covers the covered portion of the at least one of the first surface and second surface.

4. The lens of claim 1, wherein each of the first and second surfaces has the light absorbing polymer layer adhered thereon.

5. The lens of claim 1, wherein the light absorbing polymer contains an atrament.

6. The lens of claim 5, wherein the atrament is comprised of a material selected from a group consisting of polyethylene terephthalate and liquid-crystal polymer.

7. A method for fabricating a lens, the lens including a central optical portion and a peripheral supporting portion, the peripheral portion having a first surface and an opposite second surface, the method comprising:
providing a mold, the mold having a chamber comprising a central portion and a peripheral portion to respectively form the central optical portion and the peripheral supporting portion of the lens, the peripheral portion of the chamber having a first inner surface and an opposite second inner surface;
applying a light absorbing polymer on at least one of the first surface and second surface of the peripheral portion of the chamber for forming a light absorbing polymer layer;
introducing a lens material into the chamber;
heating the chamber;
forming the lens material into a lens having the central optical portion and the peripheral supporting portion; and
removing the mold to obtain the lens with the light absorbing polymer layer formed on the peripheral supporting portion thereof.

8. The method of claim 7, wherein the light absorbing material is applied on at least one of the entire first and second inner surfaces of the peripheral portion of the chamber.

9. The method of claim 7, wherein at least one of the first inner surface and second inner surface of the chamber includes a covered portion proximate to the central optical portion and an exposed portion surrounding the covered portion, and the light absorbing material is applied on the covered portion of the at least one of the first and second inner surfaces of the peripheral portion of the chamber, the exposed portion being free of light absorbing polymer layer thereon.

10. The method of claim 7, wherein the light absorbing polymer contains an atrament.

11. The method of claim 7, wherein the lens material is transparent.

12. A lens module comprising:
a lens barrel having a retaining portion with a through hole therein;
a first lens retained on the retaining portion;
a second lens;
a spacer arranged between the first and second lenses;
wherein a second lens comprises:
a central optical portion; and
a peripheral supporting portion surrounding the central optical portion, the peripheral supporting portion having a first surface and an opposite second surface, the first surface facing toward the spacer, the second surface having a light absorbing polymer layer adhered thereon.

13. The lens module of claim 12, wherein the light absorbing polymer layer covers the entire of the second surface.

14. The lens module of claim 12, wherein the second surface includes a covered portion proximate to the central optical portion and an exposed portion free of light absorbing polymer layer thereon, and the light absorbing polymer layer covers the covered portion of the second surface.
